(19) United States
(12) Patent Application Publication
(10) Pub. No.: US 2009/0058914 A1
(43) Pub. Date: Mar. 5, 2009

(54) INKJET PRINT HEAD AND METHOD THEREOF

(75) Inventors: Nam Kyun KIM, Seongnam-si (KR); Eun Bong Han, Suwon-si (KR); Kyu Suk Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/140,416

(22) Filed: Jun. 17, 2008

(30) Foreign Application Priority Data
Sep. 4, 2007 (KR) 2007-89367

(51) Int. Cl. B41J 29/38

(52) U.S. Cl. 347/17

(57) ABSTRACT

An inkjet print head to accurately determine whether a relevant nozzle is a normal nozzle or a missing nozzle according to an ink temperature sensed by a temperature sensor, and consequently, to enable the supply of high-quality inkjet print head products and improve printing quality and reliability thereof. The inkjet print head includes an ink feed hole through which ink is introduced, a plurality of ink chambers each having a nozzle, through which the ink is ejected, a plurality of individual flow paths to connect the plurality of ink chambers with the ink feed hole, and a temperature sensor provided in each of the plurality of individual flow paths and used to sense an ink temperature in an associated individual flow path when an ink bubble generated in an associated one of the plurality of ink chambers moves backward to the ink feed hole.

### CROSS-REFERENCE TO RELATED APPLICATIONS

This application claims priority under 35 U.S.C. §119(a) from Korean Patent Application No. 2007-0089367, filed in the Korean Intellectual Property Office on Sep. 4, 2007, the disclosure of which is incorporated herein by reference in its entirely.

### BACKGROUND OF THE INVENTION

1. Field of the Invention

The present general inventive concept relates to an inkjet print head, and more particularly, to an inkjet print head including a temperature sensor to sense an ink temperature in an individual nozzle, and a method thereof.

2. Description of the Related Art

A conventional inkjet print head is a device to form an image by ejecting a micro-droplet of printing ink to a desired position on a printing medium.

Inkjet print heads are typically classified based on an ink droplet ejection mechanism thereof, into a thermal drive type and a piezoelectric drive type. Of these types, the thermal drive type generates an ink bubble using a heat source and ejects an ink droplet by expansion of the bubble.

Generally, the thermal drive type print head, which ejects an ink droplet via a bubble obtained by instantaneous heating of ink, includes a plurality of ink chambers arranged on a semiconductor substrate, a heater received in each ink chamber, and a nozzle provided at each ink chamber. If ink received in the ink chambers is heated by the respective heaters, the heated ink is ejected through the nozzles.

In the above-described inkjet print head, if some of the plurality of nozzles fail to eject ink because they are clogged or due to a malfunction of the heaters corresponding to the nozzles or due to an error in a power circuit of the heater, white lines occur in a printing medium, resulting in degraded printing quality.

A nozzle, which is damaged and therefore unable to eject ink as described above, is referred to as a “missing nozzle.” There is a need to sense the missing nozzle, in order to perform a printing operation using only normal nozzles other than the missing nozzle.

As an example of a method to sense the missing nozzle, Korean Registered Patent No. 10-0636236 discloses a method to detect a missing nozzle by scanning a result printed in a printing unit.

In the method, after a test pattern is printed by ejecting ink onto a printing medium through nozzles, a scan sensor scans the test pattern, to detect the presence of a missing nozzle.

However, the above-described conventional missing nozzle detection method is problematic in that the missing nozzle detection involves a troublesome and complicated process of printing and scanning the test pattern. Another problem is that rapid detection of missing nozzles is not possible.

Japanese Patent Laid-Open Publication No. 1993-0309832 discloses an inkjet recording head, in which it is determined, on the basis of a measured temperature of a print head, whether ejection of ink from the print head is good or bad.

However, since the inkjet recording head disclosed in the above Publication, only functions to detect whether the ejection of ink is normal or abnormal by measuring an average temperature of the inkjet recording head and cannot measure the temperature of each nozzle, it has a problem of being unable to accurately detect each missing nozzle causing a white line.

### SUMMARY OF THE INVENTION

The present general inventive concept provides an inkjet print head to accurately sense an ink temperature in each nozzle and consequently, detect a missing nozzle upon mass production, and a method thereof.

Additional aspects and/or utilities of the present general inventive concept will be set forth in part in the description which follows and, in part, will be obvious from the description, or may be learned by practice of the general inventive concept.

The above and/or other aspects and utilities of the present general inventive concept are achieved by the providing an inkjet print head including an ink feed hole, through which ink is introduced, a plurality of ink chambers each having a nozzle, through which the ink is ejected, a plurality of individual flow paths to connect the plurality of ink chambers with the ink feed hole, and a temperature sensor provided in each of the plurality of individual flow paths and used to sense an ink temperature in an associated individual flow path when an ink bubble generated in an associated one of the plurality of ink chambers moves backward to the ink feed hole.

The above and/or another aspects and utilities of the present general inventive concept may also be achieved by the providing an inkjet print head including an ink feed hole, through which ink is introduced, a plurality of ink chambers each having a nozzle, through which the ink is ejected, a plurality of individual flow paths to connect the plurality of ink chambers with the ink feed hole, a temperature sensor provided in each of the plurality of individual flow paths and used to sense an ink temperature in an associated individual flow path when an ink bubble generated in an associated one of the plurality of ink chambers moves backward to the ink feed hole, and a controller to determine whether a relevant nozzle is a normal nozzle or a missing nozzle according to the ink temperature sensed by the temperature sensor.

The above and/or other aspects and utilities of the present general inventive concept may also be achieved by the providing an inkjet print head including a semiconductor substrate, an ink feed hole perforated in a predetermined region of the semiconductor substrate, through which ink is introduced, a plurality of ink chambers aligned at opposite sides of the ink feed hole and disposed on the semiconductor substrate, a plurality of individual flow paths to connect the plurality of ink chambers with the ink feed hole, a plurality of nozzles disposed, respectively, at the top of the plurality of ink chambers; a plurality of heaters disposed, respectively, at a bottom surface of the plurality of ink chambers, and a temperature sensor provided in each of the plurality of individual flow paths and used to sense an ink temperature in an associated individual flow path.

The above and/or other aspects and utilities of the present general inventive concept may also be achieved by the providing an inkjet print head to eject ink on a printing medium, including a plurality of nozzles to eject the ink on the printing medium therethrough, an ink feed hole to provide the ink to the plurality of nozzles, a plurality of temperature sensors to correspond to the plurality of nozzles and to sense a temperature of the ink when an ink bubble moves from each of the plurality of nozzles toward the ink feed hole, and a comparative output unit to compare a reference value with the sensed temperatures to determine whether one of the plurality of nozzles is missing.

The comparative output unit may determine whether one of the plurality of nozzles is missing by comparing a reference voltage value with signal values corresponding to each of the sensed temperatures.

The signal values corresponding to each of the sensed temperatures may be output from one of each of the temperature sensors.

One of the plurality of nozzles may be determined to be missing when the reference voltage value is lower than the value of the signal corresponding to the sensed ink temperature.

The inkjet print head may further include a plurality of individual flow paths to connect the plurality of nozzles with the ink feed hole.

The plurality of temperature sensors may be located on each of the plurality of individual flow paths.

The above and/or other aspects and utilities of the present general inventive concept may also be achieved by the providing an inkjet print head, including a plurality of nozzles to eject the ink on a printing medium therethrough, a plurality of temperature sensors to sense a temperature of the ink when after each of the nozzles produces an ink bubble, and a comparative output unit to compare a reference value with each of the sensed temperatures to determine whether one of the plurality of nozzles is missing.

The inkjet print head may further include an ink feed hole to supply the ink to the plurality of nozzles, and a plurality of individual flow paths to connect the plurality of nozzles with the ink feed hole, such that each of the plurality of temperature sensors senses the temperature of the ink as each of the ink bubbles flow from each of the nozzles toward the ink feed hole.

The above and/or other aspects and utilities of the present general inventive concept may also be achieved by the providing an inkjet print head apparatus, including an ink chamber to contain ink and having a heater and a nozzle, a temperature sensor disposed in a path to the ink chamber to detect a temperature of the ink, and a controller to control the heater, and to determine a missing nozzle according to a control of the heater and the detected temperature.

The above and/or other aspects and utilities of the present general inventive concept may also be achieved by the providing an image forming apparatus, including a printing unit including an inkjet print head having an ink chamber to contain ink and having a heater and a nozzle, a temperature sensor disposed in a path to the ink chamber to detect a temperature of the ink, and a controller to control the heater, and to determine a missing nozzle according to a control of the heater and the detected temperature.

The above and/or other aspects and utilities of the present general inventive concept may also be achieved by the providing a method of detecting a missing nozzle in an inkjet print head apparatus, the method including controlling a heater to heat ink in order to produce an ink bubble and eject the ink through a nozzle, detecting a temperature of the ink, and determining a missing nozzle according to the control of the heater and the detected temperature.

The determining of the missing nozzle may further include comparing a reference value with the detected temperature.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1 is a layout view illustrating an inkjet print head in accordance with an embodiment of the present general inventive concept;

FIG. 2 is a partial sectional view of FIG. 1;

FIG. 3 is a partially cut-away perspective view of FIG. 1;

FIG. 4 is a control block diagram of a circuit to detect whether a relevant nozzle is a normal nozzle or a missing nozzle via a temperature sensor provided in each individual flow path, in accordance with an exemplary embodiment of the present general inventive concept;

FIG. 5 is a graph explaining the principle of determining whether the relevant nozzle is a normal nozzle or a missing nozzle according to an ink temperature sensed by a temperature sensor of FIG. 4;

FIG. 6 is a graph illustrating an output signal from respective constituent elements of FIG. 4;

FIG. 7 is a block diagram of an image forming apparatus 700 according to another embodiment of the general inventive concept; and

FIG. 8 is a diagram of a method of detecting a missing nozzle in an inkjet print head apparatus according to an embodiment of the present general inventive concept.

### DETAILED DESCRIPTION OF THE PREFERRED EMBODIMENTS

Reference will now be made in detail to an exemplary embodiment of the present general inventive concept, examples of which are illustrated in the accompanying drawings, wherein like reference numerals refer to like elements throughout. The embodiments are described below to explain the present general inventive concept by referring to the figures.

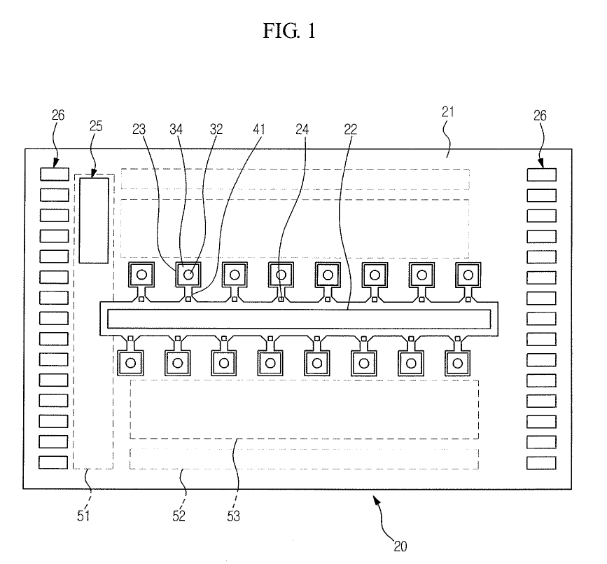

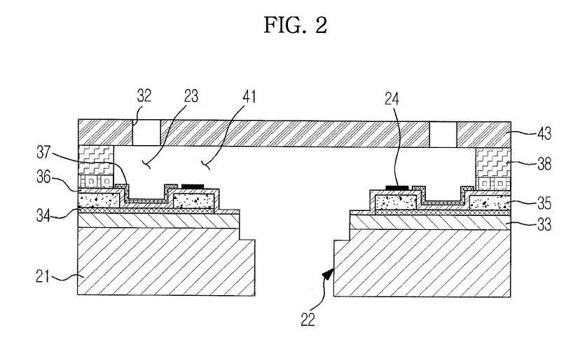

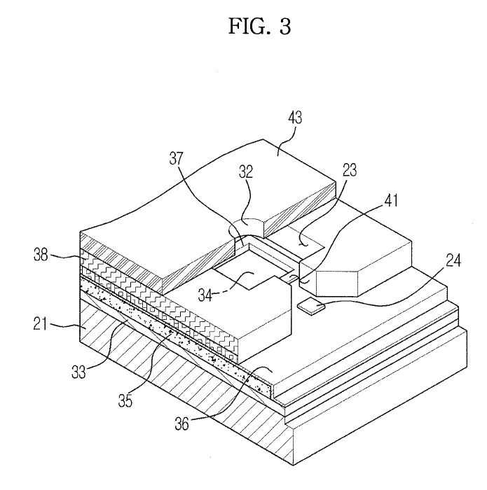

FIG. 1 is a layout view illustrating an inkjet print head in accordance with an embodiment of the present general inventive concept. FIG. 2 is a partial sectional view of FIG. 1. FIG. 3 is a partially cut-away perspective view of FIG. 1.

The inkjet print head in accordance with an exemplary embodiment of the present general inventive concept is a thermal drive type inkjet print head, which generates an ink bubble using a heat source and ejects an ink droplet by expansion of the bubble.

Referring to FIGS. 1 through 3, the inkjet print head 20 includes a semiconductor substrate 21 having an ink feed hole 22 perforated therethrough. The semiconductor substrate 21 may be a silicone substrate widely used in fabrication of integrated circuits. The ink feed hole 22 is formed in a lower portion of the semiconductor substrate 21 and is connected with an ink storage container (not illustrated). The ink feed hole 22 may have a rectangular form as illustrated in FIG. 1.

A plurality of ink chambers 23 are arranged on the semiconductor substrate 21 in such a manner that they are aligned at opposite sides of the ink feed hole 22. The ink chambers 23 are connected with the ink feed hole 22 through individual flow paths 41, respectively. If ink stored in the ink storage container is introduced into the semiconductor substrate 21 through the ink feed hole 22, the ink is fed into the plurality of ink chambers 23 through the respective individual flow paths 41. That is, the ink feed hole 22 serves as a common flow path to feed the ink to the respective individual flow paths 41.

Nozzles 32 are located at top portions of the respective ink chambers 23, such that the ink, fed into the ink chambers 23 from the ink feed hole 22, is ejected through the nozzles 32. All the nozzles 32 are formed in a nozzle plate 43, which is formed on a chamber layer 38. The nozzle plate 43 is configured to cover the ink feed hole 22, individual flow-paths 41, and ink chambers 23.

A plurality of heaters 34, as an ink ejecting device, are provided at a bottom surface of the respective ink chambers 23.

Both ends of each of the heaters 34 are electrically connected with electrodes 35 arranged on the relevant heater 34. A protective layer 36 is disposed on the heaters 34 and electrodes 35 to cover them. The protective layer 36 functions to insulate and protect the heaters 34 and electrodes 35 from the ink. The ink is ejected to the outside by heating of the heaters 34.

Upon ejection of the ink, a cavitation phenomenon may occur in an opposite direction of an ink ejecting direction, causing physical damage to the protective layer 36 and heaters 34. Therefore, to prevent the protective layer 36 and heaters 34 from being physically damaged by the cavitation phenomenon, an anti-cavitation layer 37 is further disposed on the protective layer 36 located in the ink chambers 23 and individual flow paths 41.

A plurality of metal pads 26 are arranged on both ends of the inkjet print head 20. The metal pads 26 can be positioned at the same level as the electrodes 35 on the semiconductor substrate 21. The metal pads 26 are used to electrically connect the print head 20 with an external circuit (not illustrated).

A substrate heater 25 is disposed between the metal pads 26 and the ink chambers 23. The substrate heater 25 can be positioned at the same level as the heaters 34 on the semiconductor substrate 21 and is used to heat the semiconductor substrate 21. The substrate heater 25 is electrically connected with the metal pads 26. If the ink fed into the semiconductor substrate 21 has a temperature lower than an appropriate ink ejection temperature, the semiconductor substrate 21 is heated by the substrate heater 25 to raise the ink temperature.

Logic circuit regions 51, power transistor regions 53, and address regions 52 are defined on the semiconductor substrate 21. CMOS transistors are located on the logic circuit regions 51 to perform an addressing or decoding operation. MOS transistors are located on the power transistor regions 53 and are electrically connected with the heaters 34, respectively. The MOS transistors include source and/or drain regions defined in the semiconductor substrate 21 and gate electrodes located on channel regions between the source and drain regions. The logic circuit regions 51 turn on the MOS transistors located on the power transistor regions 53 through address lines located on the address regions 52. If a specific MOS transistor in the power transistor regions 53 is turned on upon receiving a signal from an external circuit, current is applied to the heater 34 which is electrically connected with the MOS transistor. Thereby, the heater 34 is heated to a predetermined temperature, so as to generate a predetermined size of bubble in the ink received in the relevant ink chamber 23. As a result, the ink received in the ink chamber 23 is ejected, in the form of an ink droplet, through the relevant nozzle 32 by expansion of the bubble.

An insulating layer 33 is interposed between the semiconductor substrate 21 and the heaters 34. The insulating layer 33 may be a silicon dioxide (SiO2) layer.

The individual flow paths 41, which connect the respective ink chambers 23 with the ink feed hole 22, are provided with temperature sensors 24 to measure the temperature of ink fed into the ink feed hole 22. The temperature sensors 24 are provided in the respective individual flow paths 41 in a one-to-one ratio. More specifically, the temperature sensors 24 are located on the protective layer 36 at positions adjacent to the ink feed hole 22 and thus, are used to sense the temperature of ink fed into the ink feed hole 22. The temperature sensors 24 can be configured in various forms. In one example, each of the temperature sensors 24 includes temperature sensing devices doped with high-density P+ or N+ impurities via a semiconductor doping process, and a well to surround the temperature sensing device so as to minimize external electromagnetic interference.

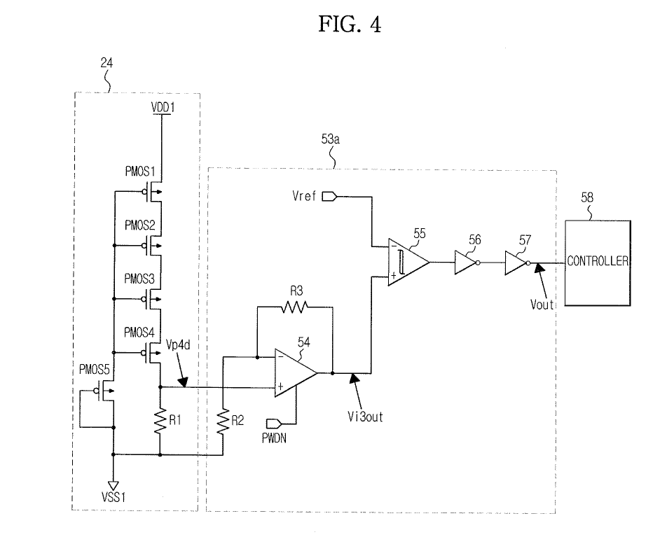

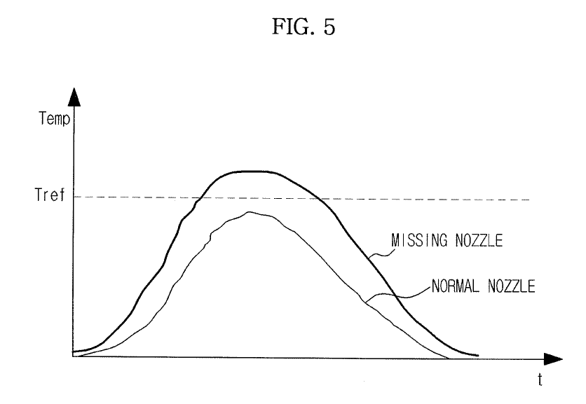

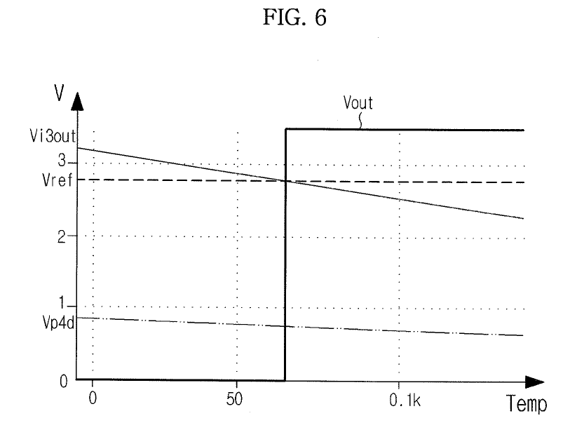

FIG. 4 is a control block diagram of a circuit, which serves to detect whether a relevant nozzle is a normal nozzle or a missing nozzle via a temperature sensor provided in each individual flow path, in accordance with an exemplary embodiment of the present general inventive concept. FIG. 5 is a graph explaining the principle of determining whether the relevant nozzle is a normal nozzle or a missing nozzle according to the ink temperature sensed by the temperature sensor of FIG. 4. FIG. 6 is a graph illustrating an output signal from respective constituent elements of FIG. 4.

As illustrated in FIG. 4, each temperature sensor 24 is electrically connected with a comparative output unit 53a. The comparative output unit 53a amplifies an output signal of the temperature sensor 24 and compares the amplified signal with a reference voltage value, to output a voltage level signal value corresponding to the comparative result. It is noted that the comparative output units 53a are provided in equal number to the temperature sensors 24, and each comparative output unit 53a is electrically connected with a controller 58. In other words, the comparative output units 53a may correspond to the temperature sensors 24 in a one-to-one ratio.

As described above, the temperature sensors 24 are located in the individual flow paths 41, which connect the ink chambers 23, corresponding to the respective nozzles 32, with the common ink feed hole 22, and in turn, the comparative output units 53a are located in the power transistor regions 53. On the basis of temperature variation of ink moving backward from the individual flow paths 41, accordingly, information about the respective individual flow paths 41 can be confirmed.

Now, the reason why the temperature sensors 24 are located in the respective individual flow paths 41 will be described. For example, considering first a normal nozzle, if a bubble generated in the ink chamber 23 expands, an ink droplet is ejected through the nozzle 32, and outside air is introduced into the ink chamber 23 through the nozzle 32. The bubble moves backward to the ink feed hole 22, together with the outside air. In this case, the ink temperature will be denoted by “A”. In contrast, considering a missing nozzle, even if a bubble generated in the ink chamber 23 expands, an ink droplet cannot be ejected through the nozzle 32 and outside air cannot be introduced into the ink chamber 23 through the nozzle 32. Likewise, the bubble moves backward to the ink feed hole 22. In this case, the ink temperature will be denoted by “B”. It is appreciated that the ink temperature “A” is lower than an initial ink temperature because of contact with the outside air, whereas the ink temperature “B” is kept at a high value because of the lack of outside air, and consequently, that the ink temperature “A” in the normal nozzle is lower than the ink temperature “B” in the missing nozzle. That is, on the basis of the ink temperature sensed by the temperature sensor 24, it is possible to determine whether the relevant nozzle is a normal nozzle or a missing nozzle as illustrated in FIG. 5.

The temperature sensing devices of the temperature sensor 24 include a plurality of P-channel MOSFETs to perform temperature sensing PMOS1 to PMOS4, a P-channel MOSFET for ground reverse current prevention PMOS5, and a resistor R1. PMOS1 to PMOS4 are connected in parallel, and gate ends of PMOS1 to PMOS4 are commonly connected with a drain end of PMOS5 having gate and source ends connected with each other. A source end of PMOS1 is connected with a drain end of PMOS2, a source end of PMOS2 is connected with a drain end of PMOS3, a source end of PMOS3 is connected with a drain end of PMOS4, and a source end of PMOS4 is connected with the source end of PMOS5 by interposing the resistor R1 therebetween. The source end of PMOS5 is connected with a ground end VSS1.

The comparative output unit 53a includes an amplifier 54 to amplify an output signal Vp4d of the temperature sensor 24, a comparator 55 to compare a voltage signal Vi3out amplified by the amplifier 54 with a preset reference voltage signal Vref and to output a voltage level signal corresponding to the comparative result, and shift resistors 56 and 57 to latch and transmit an output signal Vout (“H” or “L”) of the comparator 55 to the controller 58. The comparator 55 outputs “H” (polarity of which is reversed by an inverter provided in the comparator 55) when the reference voltage signal Vref is greater than the amplified voltage signal Vi3out, and outputs “L” when the reference voltage signal Vref is less than the amplified voltage signal Vi3out. Here, “H” indicates that the relevant nozzle is a normal nozzle, and “L” indicates that the relevant nozzle is a missing nozzle.

The controller 58 determines, based on the output signal of the comparative output unit 53a, whether the relevant nozzle is a normal nozzle or a missing nozzle.

For example, as illustrated in FIG. 6, when a voltage of 3.3V is applied to VDD1 of the temperature sensor 24, the output signal value Vp4d of the temperature sensor 24 has a measured value of 0.80V at about 0.2°, and a measured value of 0.62V at about 125°. Since the level of an initial output voltage is low, the amplifier 54 is used to amplify the voltage. The amplified voltage signal Vi3out has a measured value of 3.23V at about 0.2° and a measured value of 2.53V at about 125°. The comparator 55 compares the amplified voltage signal Vi3out with the reference voltage signal Vref, to output the final output signal Vout. If the reference voltage signal Vref is greater than the amplified voltage signal Vi3out, the output signal is “H”. Conversely, if the reference voltage signal Vref is less than the amplified voltage signal Vi3out, the output signal is “L”. Here, “H” indicates that the relevant nozzle is a normal nozzle, and “L” indicates that the relevant nozzle is a missing nozzle, as illustrated in FIG. 5. The final output signal Vout is latched and transmitted to the controller 58 through the shift resistors 56 and 57. In this way, as the ink temperature in a single ink chamber can be sensed by use of the temperature sensor 24, it can be determined individually corresponding to each of the respective nozzles whether the relevant nozzle is a normal nozzle or a missing nozzle.

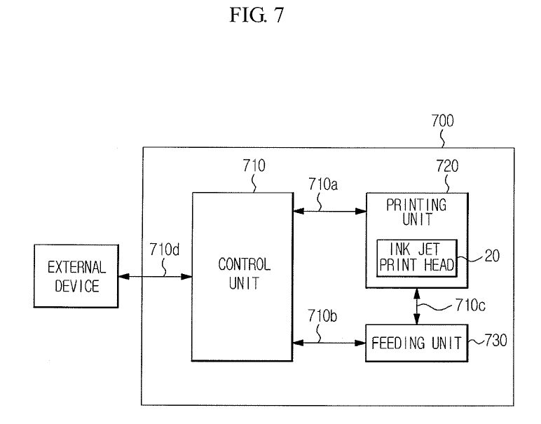

FIG. 7 is a block diagram of an image forming apparatus 700 according to another embodiment of the general inventive concept. The image forming apparatus 700 includes a printing unit 720 which includes an inkjet print head 20 having an ink chamber (not illustrated) to contain ink and having a heater (not illustrated) and a nozzle (not illustrated). A user may operate an external device (such as a computer, laptop, palm-pilot, etc.) in order to start a printing process by sending a signal, via a path 710d, to a control unit 710. When the control unit 710 receives the signal from the external device via the path 710d, the control unit activates a feeding unit 730, via a path 710b, to feed paper to the printing unit 720, and also sends a signal via a path 710a to the printing unit 720 to begin a printing process by heating up ink. The feeding unit 730 may send a signal to the printing unit 720 via a path 710c in order to prepare the printing unit 720 for incoming paper to be printed upon. There may also be a temperature sensor (not illustrated) disposed in a path to the ink chamber to detect a temperature of the ink. When the temperature of the ink is detected, the control unit 10 may control the heater and determine a missing nozzle according to the control of the heater and the detected temperature.

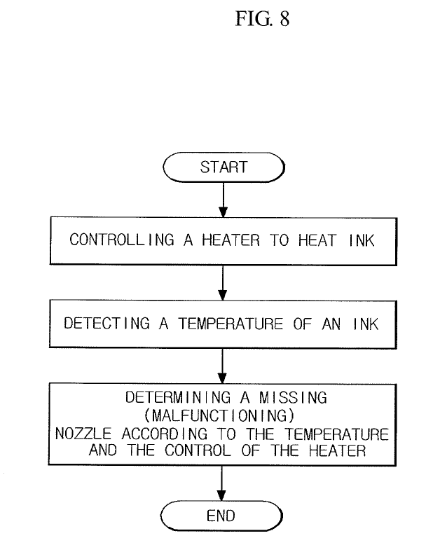

As illustrated in FIG. 8, an embodiment of the present general inventive concept includes a method of detecting a missing nozzle in an inkjet print head apparatus. Operation 820 includes controlling a heater to heat ink in order to produce an ink bubble and eject the ink through a nozzle. Operation 840 includes detecting a temperature of the ink. Finally, operation 860 includes determining a missing nozzle according to the control of the heater and the detected temperature.

As apparent from the above description, the present general inventive concept provides an inkjet print head having the following effects.

Firstly, as a result of providing a temperature sensor in each individual flow path which connects a relevant ink chamber with an ink feed hole, a temperature difference of ink between a missing nozzle and a normal nozzle can be accurately sensed per each individual flow path. This has the effect of detecting a missing nozzle upon mass production, thereby enabling the supply of high-quality inkjet print head products and preventing other possible problems.

Secondly, according to the present general inventive concept, a relatively simple circuit block can be realized. This has an advantage of enabling arrangement of constituent elements without significant changes to conventional configurations.

Thirdly, since whether or not each individual nozzle is a missing nozzle can be accurately sensed, the present general inventive concept can effectively enable the supply of high-quality inkjet print head products, and moreover, improve the printing quality and reliability of the inkjet print head.

Although embodiments of the present general inventive concept have been illustrated and described, it would be appreciated by those skilled in the art that changes may be made in these embodiments without departing from the principles and spirit of the general inventive concept, the scope of which is defined in the appended claims and their equivalents.

What is claimed is:

1. An inkjet print head, comprising:
an ink feed hole through which ink is introduced;
a plurality of ink chambers each having a nozzle, through which the ink is ejected;
a plurality of individual flow paths to connect the plurality of ink chambers with the ink feed hole; and
a temperature sensor provided in each of the plurality of individual flow paths and used to sense an ink temperature in an associated individual flow path when an ink bubble generated in an associated one of the plurality of ink chambers moves backward to the ink feed hole.

2. The inkjet print head of claim 1, wherein the temperature sensor comprises:
a plurality of P-channel MOSFETs connected in parallel to perform temperature sensing; and
a P-channel MOSFET to prevent a ground reverse current.

3. The inkjet print head of claim 1, further comprising:
a comparative output unit to amplify and compare an output signal of the temperature sensor to a reference voltage signal value, so as to output a voltage level signal corresponding to the comparative result.

4. The inkjet print head of claim 3, wherein the comparative output unit is disposed in a power transistor region, which is provided on the inkjet print head and drives heaters used to heat the ink in the plurality of ink chambers to generate an ink bubble.

5. The inkjet print head of claim 4, wherein the comparative output unit, disposed in the power transistor region, is provided in equal number to the temperature sensor.

6. An inkjet print head, comprising:
an ink feed hole through which ink is introduced;
a plurality of ink chambers each having a nozzle, through which the ink is ejected;
a plurality of individual flow paths to connect the plurality of ink chambers with the ink feed hole;
a temperature sensor provided in each of the plurality of individual flow paths and used to sense an ink temperature in an associated individual flow path when an ink bubble generated in an associated one of the plurality of ink chambers moves backward to the ink feed hole; and
a controller to determine whether a relevant nozzle is a normal nozzle or a missing nozzle according to the ink temperature sensed by the temperature sensor.

7. The inkjet print head of claim 6, further comprising:
a comparative output unit to amplify and compare an output signal of the temperature sensor, so as to output a voltage level signal corresponding to the comparative result.

8. The inkjet print head of claim 7, wherein the comparative output unit is disposed in a power transistor region, which is provided on the inkjet print head and drives heaters used to heat the ink in the plurality of ink chambers to generate an ink bubble.

9. The inkjet print head of claim 8, wherein the comparative output unit, disposed in the power transistor region, is provided in equal number to the temperature sensor.

10. An inkjet print head, comprising:
a semiconductor substrate;
an ink feed hole perforated in a predetermined region of the semiconductor substrate, through which ink is introduced;
a plurality of ink chambers aligned at opposite sides of the ink feed hole and disposed on the semiconductor substrate;
a plurality of individual flow paths to connect the plurality of ink chambers with the ink feed hole;
a plurality of nozzles disposed, respectively, at the top of the plurality of ink chambers;
a plurality of heaters disposed, respectively, at a bottom surface of the plurality of ink chambers; and
a temperature sensor provided in each of the plurality of individual flow paths and used to sense an ink temperature in an associated individual flow path.

11. The inkjet print head of claim 10, further comprising:
a comparative output unit to amplify and compare an output signal of the temperature sensor, so as to output a voltage level signal corresponding to the comparative result; and
a controller to determine whether a relevant nozzle is a normal nozzle or a missing nozzle according to the output signal of the comparative output unit.

12. The inkjet print head of claim 11, wherein the comparative output unit is disposed in a power transistor region, which drives the heaters used to heat the ink in the plurality of ink chambers to generate an ink bubble, the comparative output unit being provided in equal number to the temperature sensor.

13. An inkjet print head to eject ink on a printing medium, comprising:
a plurality of nozzles to eject the ink on the printing medium therethrough;
an ink feed hole to provide the ink to the plurality of nozzles;
a plurality of temperature sensors to correspond to the plurality of nozzles and to sense a temperature of the ink when an ink bubble moves from each of the plurality of nozzles toward the ink feed hole; and
a comparative output unit to compare a reference value with the sensed temperatures to determine whether one of the plurality of nozzles is missing.

14. The inkjet print head of claim 13, wherein the comparative output unit determines whether one of the plurality of nozzles is missing by comparing a reference voltage value with signal values corresponding to each of the sensed temperatures.

15. The inkjet print head of claim 14, wherein the signal values corresponding to each of the sensed temperatures are output from one of each of the temperature sensors.

16. The inkjet print head of claim 13, wherein one of the plurality of nozzles is determined to be missing when the reference voltage value is lower than the value of the signal corresponding to the sensed ink temperature.

17. The inkjet print head of claim 13, further comprising:
a plurality of individual flow paths to connect the plurality of nozzles with the ink feed hole.

18. The inkjet print head of claim 17, wherein the plurality of temperature sensors are located on each of the plurality of individual flow paths.

19. An image forming apparatus, comprising:
a printing unit including an inkjet print head having an ink chamber to contain ink and having a heater and a nozzle;
a temperature sensor disposed in a path to the ink chamber to detect a temperature of the ink; and
a controller to control the heater, and to determine a missing nozzle according to a control of the heater and the detected temperature.

20. A method of detecting a missing nozzle in an inkjet print head apparatus, the method comprising:
controlling a heater to heat ink in order to produce an ink bubble and eject the ink through a nozzle;
detecting a temperature of the ink; and
determining a missing nozzle according to the control of the heater and the detected temperature.

21. The method of claim 20, wherein the determining of the missing nozzle further comprises:
comparing a reference value with the detected temperature.
